(19) United States
(12) Patent Application Publication
(10) Pub. No.: US 2008/0023378 A1
(43) Pub. Date: Jan. 31, 2008

(54) Folding carton delivery system

(76) Inventors: Jean H. Madern, Vlaardingen (NL); Paul W. Bergland, Oconomowoc, WI (US); Paul Madill, Cary, NC (US)

Correspondence Address: Drinker Biddle & Reath LLP;Patent Docketing, One Logan Square, 18th and Cherry Streets, Philadelphia, PA, 19103-6996, US

(21) Appl. No.: 11/827,304

(22) Filed: Jul. 11, 2007

Related U.S. Application Data
(60) Provisional application No. 60/833,416, filed on Jul. 26, 2006.

(51) Int. Cl. B07C 5/00

(52) U.S. Cl. 209/559; 209/560

(57) ABSTRACT

A system for handling cut and creased folding carton blanks and delivering the blanks to a collecting conveyor with limited impact includes a lane adjustment section aligning the lanes, an accumulator section forming batches and a slow-down section. The lane adjustment section includes transfer assemblies each having a variable speed motor for individually adjusting the lanes and a pull roll for establishing a uniform speed. The accumulator includes a motorized drum, belts driven by the drum and a deflector moving the blanks into and out of a rotary pathway. The drum may be part of a removable drum module for modifying drum diameter. The slow-down section cyclically adjusts speed to slow each batch. An in-feed assembly provides for receipt of relatively short blanks onto opposite sides of the drum in a double batching mode to form separate batches in each lane.

### CROSS REFERENCE TO RELATED APPLICATION

This application claims priority from U.S. Provisional Patent Application No. 60/833,416, filed Jul. 26, 2006.

### FIELD OF THE INVENTION

The invention relates generally to packaging and, more particularly, to a system for delivering folding cartons used for packaging products including food products such as milk.

### BACKGROUND OF THE INVENTION

Folding cartons are used for packaging products, such as milk and other food products, for placement on commercial shelving in retail outlets. Known folding cartons are formed from a web of paperboard, typically in a roll, having a width that allows for efficient placement of individual cartons with respect to each other. The placement of cartons is chosen to conserve paperboard material, such that adjacent cartons on the web are typically not aligned with each other.

The paperboard web is cut and creased into individual carton forms, sometimes hereinafter also referred to as “carton blanks.” After a cutting and creasing operation, the carton blanks are separated in the cross machine direction by a machine known as a “skew unit” to form spaced lanes of product moving in a direction referred to as the running direction. The lanes of carton blanks are moved at a line operating speed, for example approximately 1000 feet per minute. The location of the carton blanks in the running direction is a function of how they were cut on the web of paperboard material to conserve materials. As a result, carton blanks in a given lane may not be aligned in the cross machine direction with carton blanks of other lanes.

The carton blanks are directed to a collecting conveyor for off-loading by personnel (e.g., removal of the carton blanks from the conveyor and placement onto shipping devices for transport to subsequent processing operations). The collecting conveyor moves the carton blanks at a relatively slow speed, for example 5 feet per minute, that is suitable for handling by the personnel. Impact forces acting on the carton blanks during transfer to the relatively slow-moving collecting conveyor create an unpredictable and random location of the carton blanks. As a result, the effort required by personnel to remove the carton blanks from the collecting conveyor and place them onto shipping devices is significantly increased.

What is needed is a folding carton delivery system that reduces the impact forces acting on the carton blanks during transfer of the blanks onto the relatively slowly moving collector conveyor, thereby providing a more uniform and predictable placement of carton blanks on the collector conveyor.

### SUMMARY OF THE INVENTION

The invention provides a system for handling carton blanks formed in a cutting and creasing operation in a plurality of lanes of carton blanks moving at a running speed and delivering the carton blanks to a collecting conveyor moving at a reduced speed suitable for handling of the carton blanks by personnel. The handling and delivering system of the present invention is adapted to reduce the speed at which the carton blanks are delivered to the collecting conveyor, thereby limiting impact forces acting on the carton blanks.

According to one embodiment, the system includes a lane adjustment section for aligning the lanes of carton blanks with each other in a cross-machine direction, an accumulator section for creating batches of stacked carton blanks, and a slow-down section for reducing the speed of the batches of carton blanks. The lane adjustment section includes a plurality of transfer assemblies each adapted to move a lane of carton blanks in a running direction from an inlet end of the lane adjustment section to a discharge end. Each of the transfer assemblies includes a variable speed motor for individually adjusting the speed of the associated lane to align the lanes with each other. The lane adjustment section includes a motor-driven pull roll adjacent the discharge end for establishing a uniform speed in all of the lanes. The lane adjustment section preferably includes a registration system adapted to monitor the lanes of carton blanks for misalignment adjacent the inlet end of the lane adjustment section.

The slow-down section includes a variable speed drive motor for cyclically varying the motor speed to adjust the speed of each batch of carton blanks from a first speed at an inlet end of the slow-down section to a second speed at an exit end. The second speed reduced from the first speed sufficiently to limit impact forces acting on the batch during transfer of the batch to a collecting conveyor. Servomotors may be used as the variable speed motors of the lane adjustment section and the variable speed motor of the slow-down section.

According to one embodiment, the accumulator section includes a rotary accumulator for creating batches of stacked carton blanks in each lane. The rotary accumulator includes a rotatably supported drum, a drum motor driving the drum, and at least one drum belt supported on rollers to contact an outer surface of the drum such that the drum belt is moved about the rollers by the drum. The rotary accumulator also includes a deflector located beneath the drum and movable between a raised position in which carton blanks moving in the running direction are directed upwardly for movement about a rotary path defined about the drum and a lowered position in which the carton blanks pass beneath the drum in the running direction. The drum motor may also be a servomotor. The deflector assembly may include a plurality of vanes supported on a vane shaft, a rotatably supported cam wheel driven by a servomotor.

The accumulator section may also include an in-feed assembly located between the pull roll of the lane adjustment section and the deflector assembly of the accumulator section. The in-feed assembly defines a nip point adjacent the deflector assembly to provide for both a single batching mode and an alternative double batching mode. In the single batching mode only one batch of carton blanks is being formed in each lane at any given time. The nip point defined by the in-feed assembly provides for handling of relatively short carton blanks such that carton blanks are receivable on each of opposite sides of the drum for forming separate batches of stacked carton blanks in each lane at the same time. The in-feed assembly includes a plurality of belts each supported on pulleys and a drive roll and a drive motor rotatingly driving the drive roll. The drive motor for the drive roll may also be a servomotor. The in-feed assembly may also include cam assemblies each having a sloped cam surface and an adjacent cam follower wheel adapted to define a nip point with one of the belts of the in-feed assembly.

According to one aspect of the invention, the rotary accumulator of the accumulator section includes a drum module assembly adapted for removal from a frame assembly supporting the drum module. The drum module preferably includes the drum, the drum drive motor, the drum belts and the rollers supporting the drum belts. According to one embodiment of the invention, the system includes a plurality of drum modules having drums of differing diameter to facilitate replacement of drums having different diameters. The system may include at least one lift assembly secured to the frame assembly and adapted to lift the drum module with respect to the frame assembly to facilitate removal and replacement of the drum module.

According to another aspect of the invention, a method is provided for handling carton blanks arranged in a plurality of spaced lanes moving in a running direction and delivering the carton blanks to a collecting conveyor. The method includes the steps of monitoring the lanes for misalignment between the lanes and aligning the lanes by individually adjusting the speed of one or more of the lanes. The method includes the steps of establishing a uniform speed for all of the lanes following the step of aligning, forming batches of stacked carton blanks in each lane, and slowing the speed of each batch to limit impact forces acting on the batch during discharge of the batch to a collecting conveyor. The step of slowing may include the step of cyclically varying the speed of a servomotor to reduce the speed of each batch.

Another method for handling lanes of folding carton blanks includes the steps of providing a rotatably supported drum having a circumference sufficient to receive carton blanks on each of opposite first and second sides of the drum in each lane, providing a drum motor driving the drum and providing a deflector located beneath the drum and movable between raised and lowered positions. The method includes the step of raising the deflector to the raised position and maintaining the deflector in the raised position during at least one revolution of the drum such that at least one carton bank is directed into the rotary path onto each of the first and second sides of the drum in each lane. The method includes the steps of lowering the deflector to the lowered position in a discharging cycle during a one-half revolution of the drum to discharge one or more stacked carton blanks from the first side of the drum in each lane onto an incoming carton blank to form a batch of carton blanks moving in the running direction. The method includes the step of repeating the above steps of raising, maintaining, lowering and maintaining the deflector to discharge one or more stacked carton blanks from the second side of the drum in each lane onto an incoming carton blank to form a batch of carton blanks. The above procedure is then repeated such that carton blanks are discharged from the first and second sides of the drum in discharging cycles in alternating fashion to form batches of carton blanks.

### BRIEF DESCRIPTION OF THE DRAWINGS

For the purpose of illustrating the invention, the drawings show a form of the invention that is presently preferred. However, it should be understood that this invention is not limited to the precise arrangements and instrumentalities shown in the drawings.

FIG. 1 is side elevation view, partly in section, of a folding carton delivery system according to an exemplary embodiment of the invention.

FIG. 2 is a schematic view showing a manufacturing process including the folding carton delivery system of the present invention.

FIGS. 3 and 4 are schematic plan views respectively showing lanes of carton blanks adjacent an entry end and a discharge end of the lane adjustment section of the folding carton delivery system of the present invention.

FIG. 5 is a side elevation view of a base portion of the lane adjustment section of the folding carton delivery system of FIG. 1 viewed from an operator side of the lane adjustment section.

FIG. 6 is a top plan view of the base portion of the lane adjustment section.

FIG. 7 is a top plan view of the base portion of the lane adjustment section shown without cover plates.

FIG. 8 is an end view of the base portion of the lane adjustment section viewed from a web going end of the lane adjustment section.

FIG. 9 is a sectional view of the base portion of the lane adjustment section viewed from a web coming end of the lane adjustment section.

FIGS. 10-12 are views of a skate wheel assembly associated with transfer belts of the lane adjustment section.

FIGS. 13-15 are views of a skate wheel assembly associated with a pull roll of the lane adjustment section.

FIG. 16 is a side elevation view, in section, of the accumulator and slow-down sections of the folding carton delivery system.

FIG. 17 is a plan view of the accumulator and slow-down sections.

FIG. 18 is a plan view of base portion s of the accumulator and slow-down sections.

FIG. 19 is a side elevation view of the accumulator and slow-down sections.

FIGS. 20 and 21 are views of a van e assembly of the accumulator section.

FIGS. 22 through 24 are views of a vane drive assembly of the accumulator section.

FIGS. 25 and 26 are views of a vane cam of the vane drive assembly.

FIG. 27 is a view schematically illustrating a first carton blank of a lane of carton blanks rotating on the drum of the rotary accumulator and a second carton blank of the lane being directed towards the drum following carton blank succeeding carton blank being directed to the drum during formation of a batch of carton blanks.

FIG. 28 is a view schematically illustrating a batch of five carton blanks being discharged from the drum of the rotary accumulator.

FIG. 29 is a view schematically illustrating an alternative arrangement in which two carton blanks of the same lane are received on the drum of the rotary accumulator.

FIGS. 30 and 31 are views of a time belt drive assembly of the slow-down section.

### DESCRIPTION OF THE INVENTION

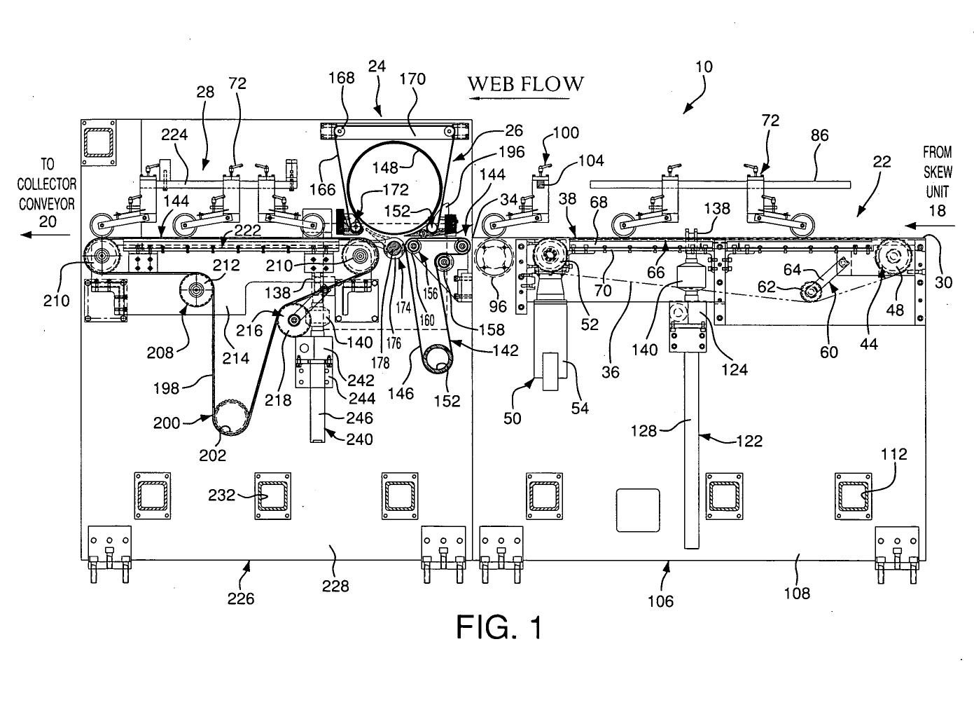

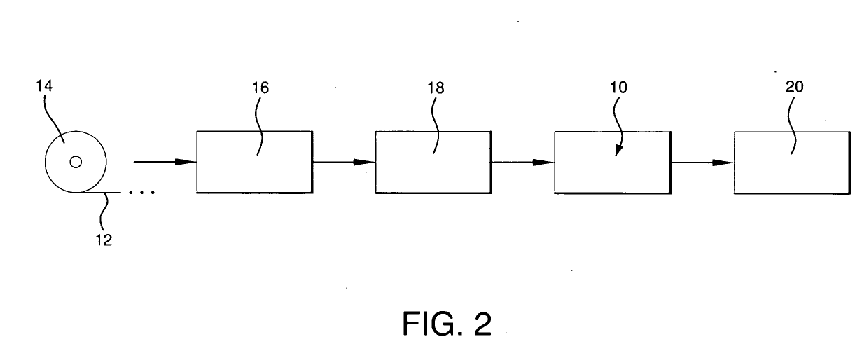

Referring to the drawings, where like numerals identify like elements, there is illustrated in FIG. 1 a folding carton delivery system 10 according to an exemplary embodiment of the invention. As illustrated schematically in FIG. 2, the folding carton delivery system 10 of the present invention is adapted to form part of a folding carton manufacturing process. The folding cartons are formed from a web 12 of material, which is typically paperboard stored in the form of a roll 14. The web 12 of material may be pre-printed to include indicia associated with the cartons that are to be formed from the material or may be unprinted. As shown, the web 12 is directed from the roll 14 to a cut and crease operation 16. In this stage of the process, individual cartons are cut from the web 12 and are creased with fold lines. Preferably, the cartons are cut from the web 12 in a rotary die-cutter. The individual cut and creased folding cartons are hereinafter sometimes referred to as “carton blanks.” The arrangement of the carton blanks on the web 12 of material is typically adapted for material-saving efficiencies and may involve nesting of the carton blanks on the web 12. The carton blanks are directed from the cut and crease operation 16 to a skew unit 18. The purpose of the skew unit 18 is to spread the individual carton blanks formed in the cut and crease operation 16 into spaced apart lanes of carton blanks. As a result of the material-saving arrangement of the carton blanks on the web 12, however, the carton blanks discharged from the skew unit 18 may not be aligned with each other in a cross machine direction (i.e., carton blanks in a given lane may not be aligned with carton blanks in adjacent lanes).

The folding carton delivery system 10 of the present invention is adapted to receive the lanes of carton blanks from the skew unit 18 at a line operating speed, such as approximately 1000 feet per minute for example. The delivery system 10 of the present invention is adapted to significantly reduce the speed at which the lanes of carton blanks are moving, thereby facilitating an orderly transfer of the carton blanks to a collector conveyor 20 which moves at a relatively slow speed, such as approximately 5 feet per minute for example. The relatively slow speed at which the carton blanks are moved by the collector conveyor 20 allows personnel to handle the carton blanks (e.g., to remove the folding carton blanks from the collecting conveyor 20 and place them onto shipping devices for transport to subsequent processing operations). As described below in greater detail, the folding carton delivery system 10 is adapted to form batches of stacked carton blanks in each of the lanes received from the skew unit 10 to provide for the desired slow down. The resulting uniformity and predictability in which the carton blanks can be placed onto a collector conveyor 20 greatly facilitates handling of the carton blanks by personnel. Each of the web roll 14, the cut and crease operation 16, the skew unit 18 and the collecting conveyor 20 of FIG. 2 is well known and, therefore, no further description is required.

Referring again to FIG. 1, the delivery system 10 includes a lane adjustment section 22, an accumulator section 24, and a slow-down section 28. The accumulator section 24 includes a rotary accumulator 26 that, in the manner described below, forms batches of stacked carton blanks from each lane of individual folding carton blanks received from skew unit 18 at line operating speed (e.g., approx. 1000 feet per minute). The slow-down section 28 reduces the speed of the batches of carton blanks received by the slow-down section 28 from the accumulator section.

The Lane Adjustment Section

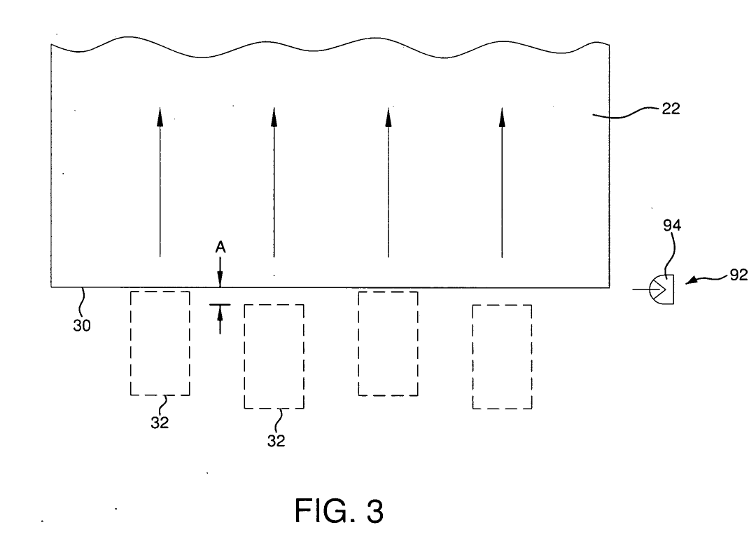

Referring to the schematic illustration of FIG. 3, an entry (or front) end 30 of the lane adjustment section 22 is shown. The lane adjustment section 22 is shown receiving carton blanks 32 from the skew unit 18 in four lanes of carton blanks 32 each moving in a machine running direction shown by an arrow. The carton blanks 32 are illustrated in broken line as rectangles to facilitate illustration, it being understood that the cut and creased folding cartons will likely vary in appearance from that shown such that they define irregular borders.

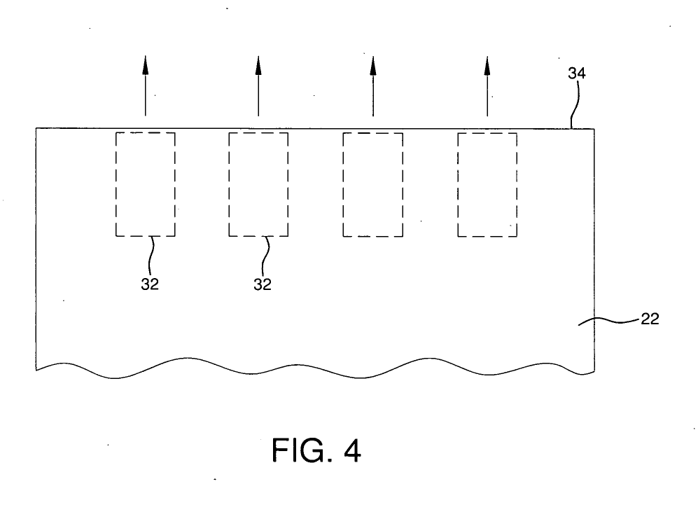

As shown in FIG. 3 and discussed above, the lanes of carton blanks 32 are not all aligned with each other at the entry end 30 of the lane adjustment section 22. The misalignment between the carton blanks 32 of the first and third lanes (from left to right in the view shown in FIG. 3) and the second and fourth lanes is represented by the distance, A. One reason for such misalignment is the above-mentioned material-saving placement (e.g., nesting) of the cartons on the web 12 from which the cartons are formed. As described below, the lane adjustment section 22 is adapted to adjust the lanes of carton blanks with respect to each other such that the carton blanks are directed from the lane adjustment section 22 to the accumulator section 24 of the system 10 in an aligned condition in the cross-machine direction. Referring to FIG. 4, a discharge end 34 of the lane adjustment section 22 is illustrated schematically. As shown, the lanes have been adjusted by the lane adjustment portion 22 such that the carton blanks 32 of all lanes are aligned with each other at the discharge end 34 in the cross-machine direction.

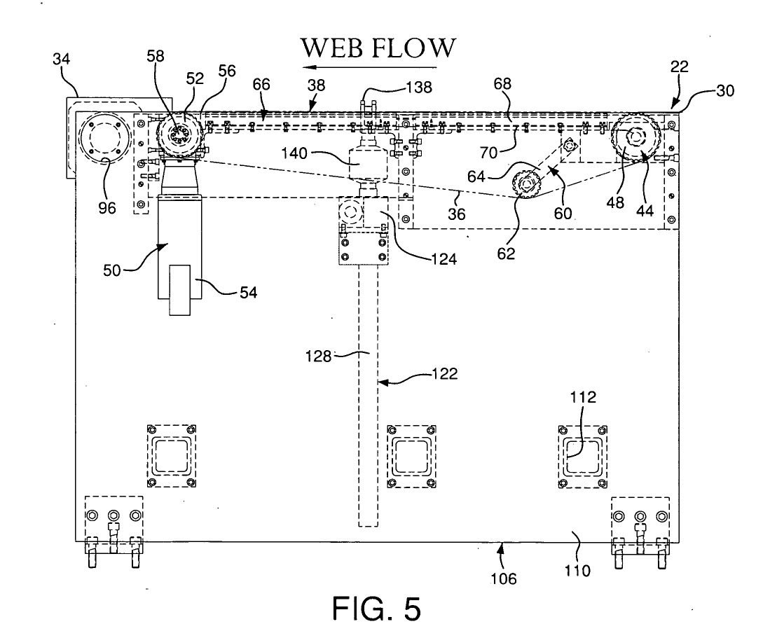

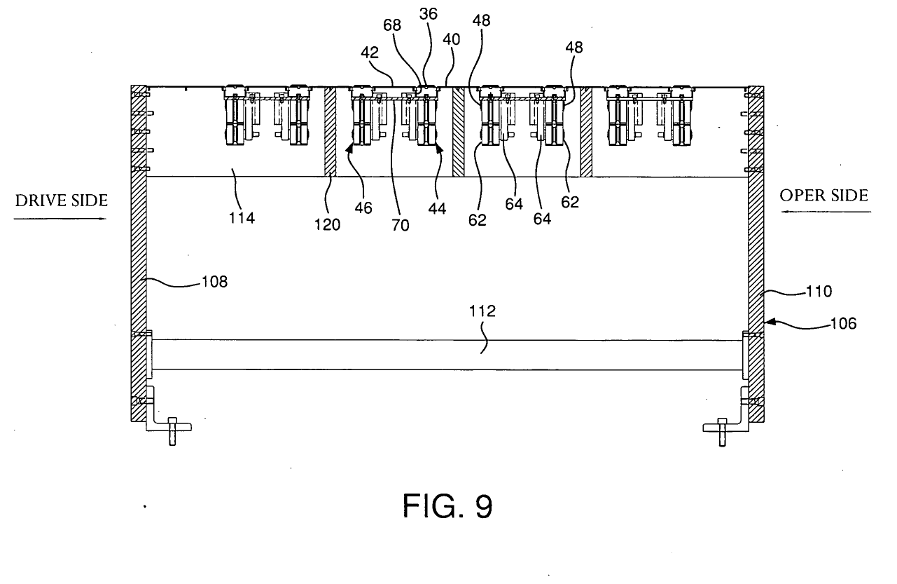

Referring to FIGS. 5-9, the lane adjustment section 22 includes a plurality of transfer belts 36 mounted on a base assembly 38 of the lane adjustment section 22. The transfer belts 36 are arranged to contact the lanes of carton blanks 32 adjacent the entry end 30 of the lane adjustment section 22 and move the carton blanks 32 along an upper deck surface defined by the base assembly 38 in a running direction. As identified in FIG. 5 by the arrow labeled “WEB FLOW”, the running direction for the lane adjustment section 22 is from the right to the left in the view shown.

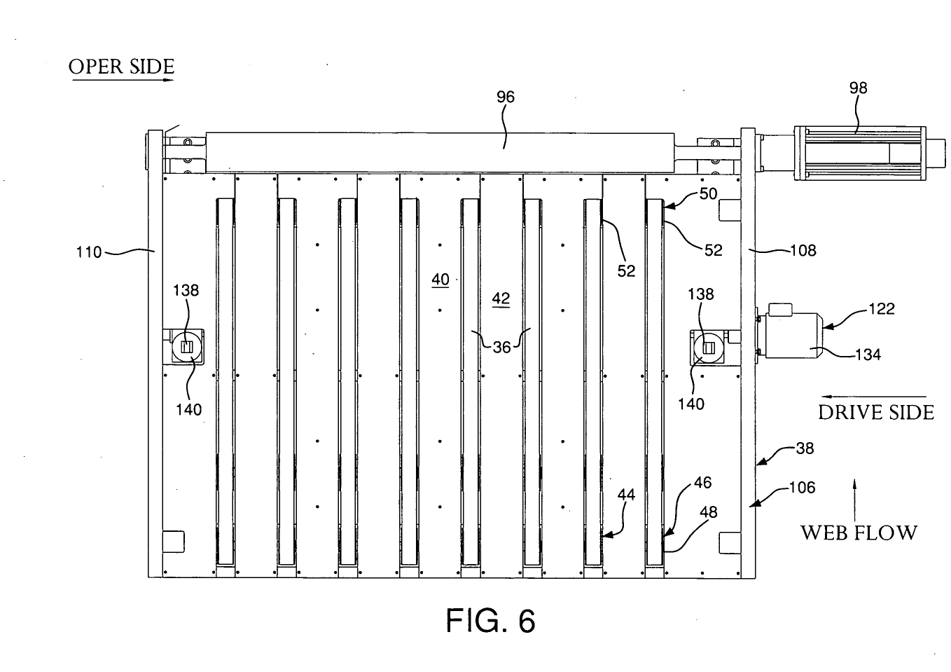

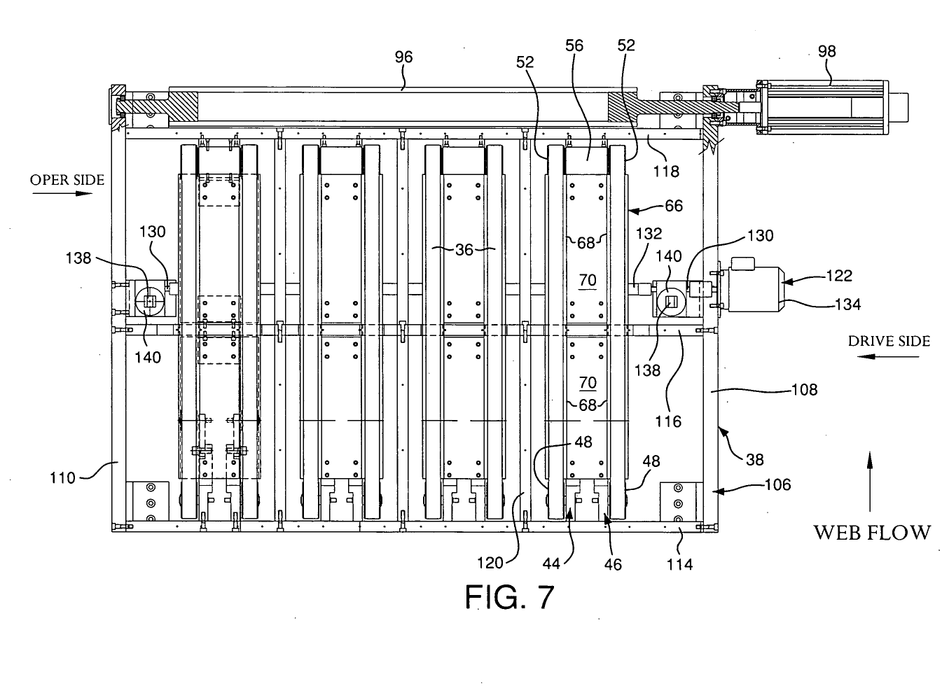

The base assembly 38 of the lane adjustment section 22 is shown in FIG. 6 with cover plates 40, 42 extending longitudinally (i.e., in the running direction) along the upper deck surface of the base assembly 38, and in FIG. 7 with the cover plates removed. The eight transfer belts 36 of the base assembly 38 are arranged into four pairs of belts. Each pair of the transfer belts 36 is adapted to contact and move one of the four lanes of carton blanks 32, illustrated schematically in FIGS. 3 and 4, along the upper deck surface of the base assembly 38 in the running direction (i.e., from the bottom to the top of the view in FIGS. 6 and 7).

Each pair of transfer belts 36 is mounted on the base assembly 38 adjacent the entry end 30 of the lane adjustment section 22 by idler pulley assemblies 44, 46. The idler pulley assemblies 44, 46 respectively comprise a left-hand idler pulley assembly 44 and a right-hand idler pulley assembly 46. Each of the assemblies 44, 46 includes an idler pulley 48 supporting one of the transfer belts 36 of the associated pair of transfer belts.

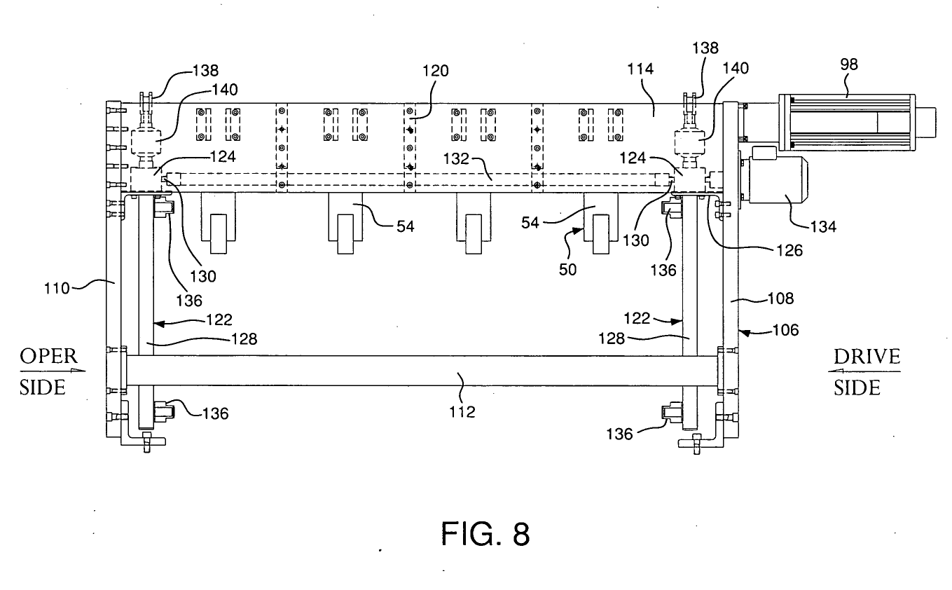

Each pair of transfer belts 36 is also mounted on a motorized pulley assembly 50 located towards the discharge end 34 of the lane adjustment section 22. Each motorized pulley assembly 50 includes a pair of drive pulleys 52 and a servomotor 54, as shown in FIGS. 5 and 8. The pair of drive pulleys 52 are supported on opposite sides of a gear head 56 on shaft ends 58. Arranged in this manner, the servomotor 54 drives the gear head 56 for simultaneous rotation of the drive pulleys 52 of the drive pulley pair. As a result, both transfer belts 36 of the pair will be driven at an identical speed by the servomotor 54 that is associated with that pair of transfer belts.

As shown in FIGS. 5 and 6, each of the idler pulley assemblies 44, 46 of the lane adjustment section 22 includes a belt tensioner 60. The belt tensioner 60 includes a pulley 62 rotatably mounted on a bracket 64 for contact with the associated transfer belt 36 such that the tensioner applies a desired tension to that transfer belt 36.

Referring to FIG. 7, the lane adjustment section 22 includes a plurality of belt slide assemblies 66. The belt slide assembly 66 includes a pair of slider beds 68 each defining an elongated track-like interior in which an associated one of the transfer belts 36 is received to guide the transfer belt 36 along the running direction of the lane adjustment section 22 as the transfer belt 36 is driven by its servomotor 54. The pair of slider beds 68 is supported on a slider bed plate 70.

As shown in FIG. 7, a small gap is provided between the belt slide assembly 66 and the transfer belts 36 to minimize potential friction caused by the belts contacting the slider base. The slider base 66, however, provides a means of controlling the vertical position of the belt path when the skate wheel assemblies 72, described below, exert their nip force on the folding cartons to assure that the speed of the folding carton matches that of the transfer belts 36.

As shown in FIG. 7, the lane adjustment section includes eight (8) belt slide assemblies 66. The belt slide assemblies 66 are arranged into four sets of two assemblies 66. As shown, the slider beds 68 in each set are arranged in end-to-end fashion such that a substantially continuous track-like interior is provided for each of the transfer belts 36 extending along the length of the lane adjustment section 22.

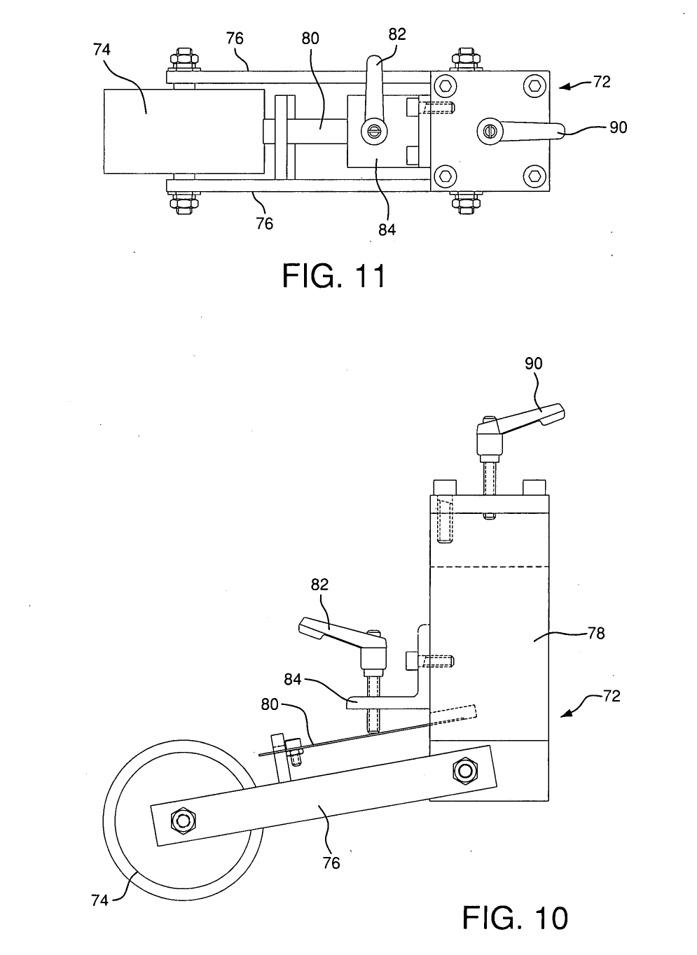

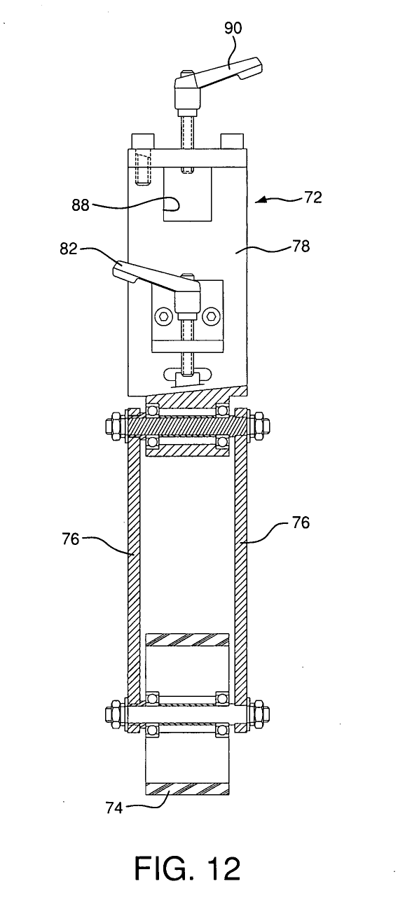

Referring again to FIG. 1, the lane adjustment section 22 includes a plurality of skate wheel assemblies 72. Each skate wheel assembly 72, which is shown in greater detail in FIGS. 10-12, includes a rotatably mounted skate wheel 74. The skate wheel assemblies 72 place the skate wheels 74 into contact with the upper surfaces of the carton blanks 32 to press the carton blanks 32 against the transfer belts 36 of the base assembly 38. Such contact by the skate wheels 74 maintains predictable movement of the carton blanks 32 by the transfer belts 36 along the lane adjustment section 22. The skate wheel 74 of the skate wheel assembly 72 is supported at one end of a pivot arm 76 that is rotatably connected at an opposite end to a support bracket 78. As shown in FIG. 10, an elongated spring member 80 is coupled between the pivot arm 76 and the support bracket 78 for applying a biasing force that directs the skate wheel 74 into contact with the carton blanks 32. An adjustment member 82 is mounted to an angle bracket 84 for adjusting the biasing force of the spring member 80.

The skate wheel assemblies 72 of the lane adjustment section 22 are arranged in sets of two assemblies 72, each set of two being associated with one of the transfer belts 36. Referring to FIG. 1, each set of skate wheel assemblies 72 is supported on an elongated beam 86 extending longitudinally along the lane adjustment section 22 (i.e., parallel to the running direction). The beam 86 is received through an aperture 88 defined the support bracket 78 adjacent an upper end of the support bracket 78. Each skate wheel assembly 72 includes an adjustable locking member 90 for securing the skate wheel assembly 72 to the beam 86 at a desired location along the beam 86. This arrangement allows adjustment of the position of the skate wheel assemblies 72 along the length of the beam 86. As described above, the depicted lane adjustment section 22 includes two skate wheel assemblies 72 in each set. It should be understood, however, that the number of skate wheel assemblies in each set could vary from that shown

Providing separate drive means for each pair of transfer belts 36 of the lane adjustment section 22 in the above described manner provides for the desired adjustment in the relative positioning of the lanes of carton blanks 32 in the following manner. The controller for the carton handling system 10 (not shown) adjusts the servo motors 54 of the lane adjustment section 22 and sets the relative speed at which the transfer belts are driven. If the four lanes of cartons are aligned, in the cross machine direction, the speed of each servo motor 54 will be matched thus maintaining alignment as the carton blanks 32 travel through the lane adjustment section. In this case the speed of each servo motor will be set so that the speed of the carton blanks 32 match the speed of the pull roll 96 described below. Referring again to FIG. 3, showing a misalignment of the carton lanes, such as the distance A shown in FIG. 3, the controller for the carton handling system 10 will set the speed of the servo motors 54 for lanes 2 and 4 such that the speed of the transfer belts 36 for those lanes exactly equals the surface speed of the pull roll 96. The controller will also set the speed of the servo motors 54 for lanes 1 and 3 sufficiently slower thus increasing the time for the carton blanks 32 to travel through the lane adjustment section and thus establishing the cross machine alignment of the carton blanks.

Referring again to FIG. 3, the folding carton delivery system 10 preferably includes a registration system 92 including a register eye 94 (or eyes) located adjacent the entry end 30 of the lane adjustment section 22. The registration system 92 is preferably adapted to monitor each lane of carton blanks 32 to detect misalignments in the cross-machine direction between the leading ends of the carton blanks of the lanes, such as the distance A shown in FIG. 3. Suitable registration systems include those used on printing decks for maintaining registration in multiple lanes of product from color to color and from print to cut, such as the registration systems used in the printing machinery by Bosch Rexroth of Lohr Am Main, Germany. Such registration systems are well known and no further description is necessary.

When the registration system 92 detects a misalignment in the cross-machine direction between the leading edges of the carton blanks 32 in the lanes of carton blanks (e.g., the distance A in FIG. 3), the controller of the folding carton delivery system 10 adjusts the servomotors 54 of the lane adjustment section 22 in the above-described manner to vary the relative speeds at which the transfer belts 36 are driven. Although the preferred manner described above for adjusting carton blank lanes is to slow down leading cartons with respect to lagging cartons, the invention is not so limited. The lane adjustment section could alternatively be adapted to speed up lagging cartons with respect to leading cartons in order to eliminate cross-machine misalignments monitored by the registration system 92

The secondary function of the registration system 92 is to assure that the timing of the flow of carton blanks 32 through the lane adjustment section is properly controlled. It is important that the leading edge of the carton blanks 32 arrive at the outgoing edge of the deflector vanes 176 of the accumulator section 26 when the vane reaches its uppermost position. The registration system 92 will adjust the speed of all servo motor 54 driving transfer belts 36 so as to maintain that timing.

Referring to FIG. 1, the folding carton delivery system 10 includes a pull roll 96 rotatably supported such that the pull roll extends substantially perpendicular to the transfer belts 36 of the lane adjustment section 22 (i.e., such that the pull roll extends in the cross machine direction). The pull roll 96 is located adjacent the discharge end 34 of the lane adjustment section 22 such that the pull roll receives the carton blanks 32 from the transfer belts 36. A servomotor 98 rotates the pull roll 96 at a rate such that the speed of the carton blanks 32 exactly matches the speed of the accumulator drum 26 described below such that all of the carton blanks 32, now aligned in the cross-machine direction in the above-described manner, will be discharged from the lane adjustment section 22 at a uniform speed. This speed setting feature provided by the pull roll 96 is necessary to correct for the above-described variation in speed between the lanes of carton blanks 32 in the lane adjustment section 22 for aligning the carton blanks 32 in the cross-machine direction. The controller of the carton handling system 10 preferably sets the speed of the servomotor 98 to establish a uniform speed for the carton blanks 32 that will match the speed at which the carton blanks 32 are subsequently moved in the accumulator section 24 of the system 10.

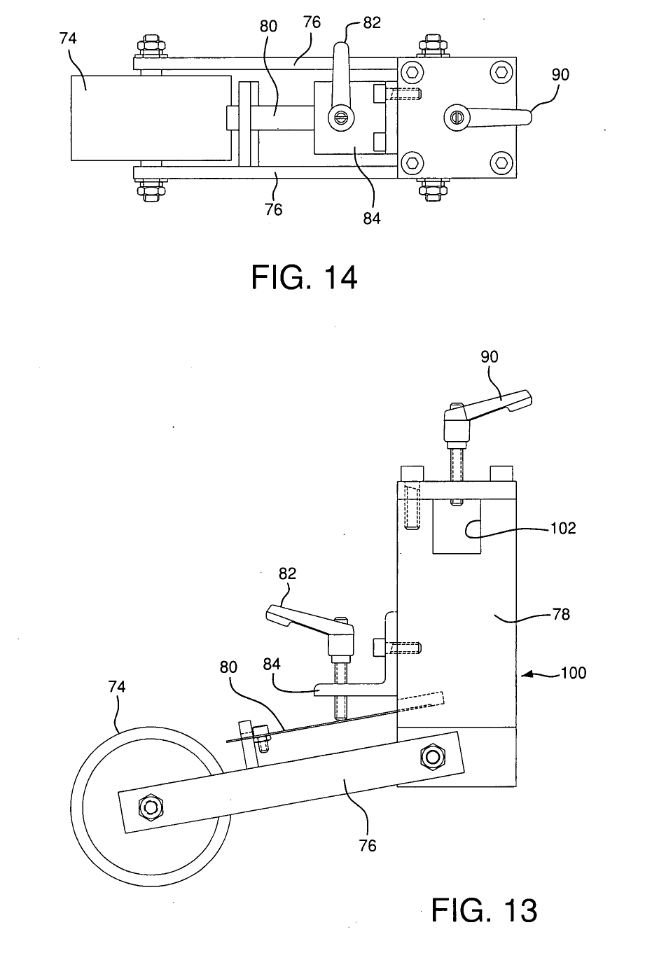

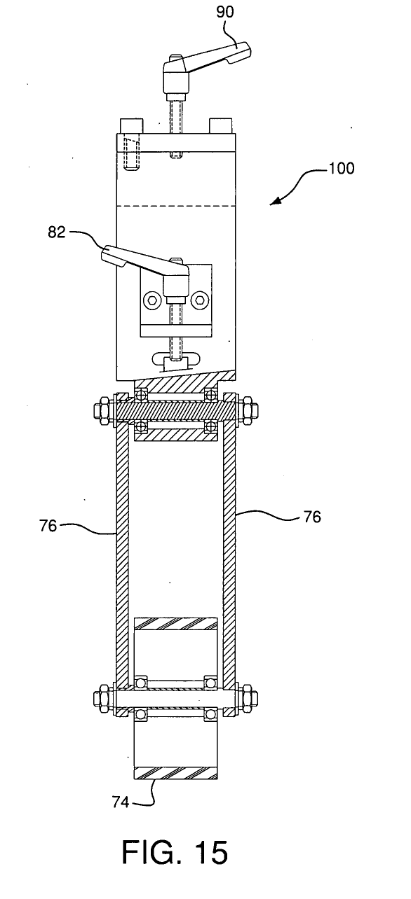

The folding carton delivery system 10 includes a plurality of skate wheel assemblies 100 adjacent the pull roll 96. The purpose of the skate wheel assemblies 100 of the lane adjustment section 22 is to ensure contact between the carton blanks 32 and the pull roll 96 at the discharge end of the lane adjustment section 22. The skate wheel assembly 100 is shown in greater detail in FIGS. 13-15. The skate wheel assembly 100 is substantially similar in construction to the skate wheel assembly 72 associated with the transfer belts 36. The skate wheel assembly 100, however, includes an aperture 102 adapted for receiving an elongated beam 104 that extends perpendicular to the pivot arm 76 and skate wheel 74 instead of parallel to the pivot arm and skate wheel like skate as in skate wheel assembly 72.

The lane adjustment section 22 includes a frames and spreaders assembly 106 for supporting the above-described elements of the lane adjustment section 22. The frames and spreaders assembly 106 include a drive side frame 108 and an operator side frame 110. The assembly 106 includes three lower spreaders 112 extending between the frames 108, 110 in a lower portion of the assembly 106. The assembly 106 includes an incoming upper spreader 114, a middle upper spreader 116, and an outgoing upper spreader 118, each extending between the frames 108, 110 in an upper portion of the assembly 106. The assembly 106 includes longitudinal upper spreaders 120 extending between the incoming upper spreader 114 and the outgoing upper spreader 118 (i.e., longitudinally in the running direction of the lane adjustment section 22).

The lane adjustment section 22 includes a screw jack assembly 122 mounted to the frames 108, 110 of the frames and spreaders assembly 106 (see FIG. 5). The screw jack assembly 122 is located beneath the transfer belts 36 of the lane adjustment section 22 to facilitate clearing of materials and jam-ups occurring above the screw jack assembly 122 (e.g., on the base assembly 38 of the lane adjustment section 22 adjacent the transfer belts 36). The screw jack assembly 122 includes a pair of screw boxes 124 each supported on supports 126 respectively mounted to one of the opposite frames 108, 110 of the frames and spreaders assembly 106. The screw jack assembly 122 includes a pair of elongated lift screws 128 each extending though one of the screw boxes 124 and engaging a lift drive member 130 housed within the screw box 124 such that rotation of the lift drive member 130 translates the associated lift screw 128 with respect to the screw box 124 (i.e., raises or lowers the lift screw 128). An elongated connecting shaft 132 interconnects the pair of lift drive members 130 for common rotation. A drive motor 134 is mounted to the drive side frame 108 and is coupled to one of the lift drive members 130 to rotatingly drive the interconnected lift drive members 130. Arranged in this manner, actuation of the drive motor 134 results in simultaneous raising or lowering of the pair of lift screws 128.

The screw jack assembly 122 includes two pairs of limit switches 136. Each pair of limit switches 136 is secured to an associated one of the lift screws 128 at spaced locations on the lift screw 128. The limit switches 136 sense location to limit the range of movement of the lift screw 128 when the lift screws 128 are raised from the position shown. Above the screw boxes 124, a forked head 138 and bellows 140 are provided on each of the lift screws 128. As should be understood, the screw jack assemblies 122 are thus adapted to provide a lifting force for elevating components of the folding carton delivery system 10 using suitable lift structure received on the forked heads 138 of the lift screws 128.

The Accumulator Section

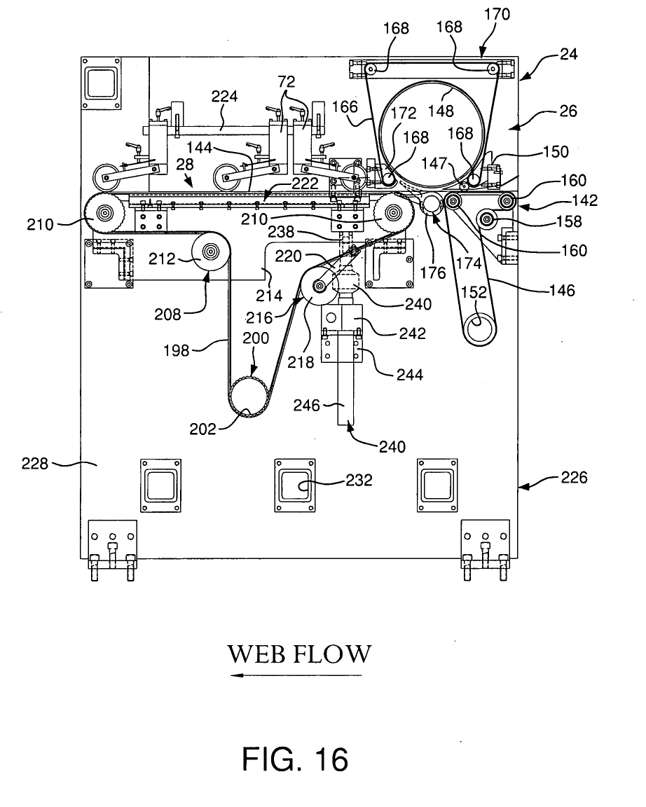

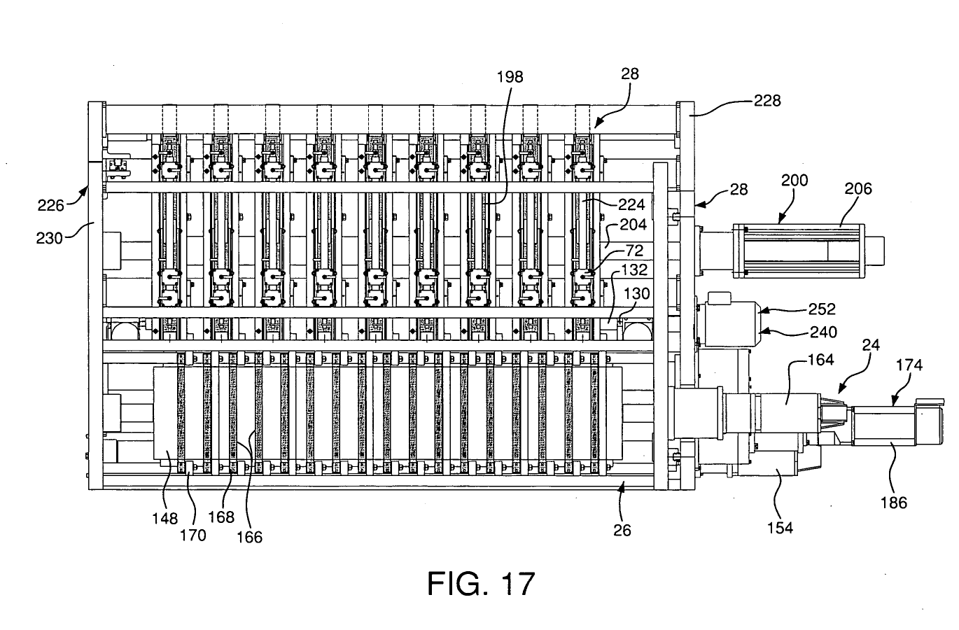

Referring again to FIG. 1, the lanes of carton blanks 32 after being aligned by the lane adjustment section 22 are directed to the accumulator section 24. The accumulator section 24 is shown with the slow-down section 28 in FIGS. 16 and 17 separately from the lane adjustment section 22. The accumulator section 24 includes a rotary accumulator 26 and an in-feed assembly 142. The in-feed assembly 142 receives the lanes of carton blanks 32 from the lane adjustment section 22 at the uniform speed set by the pull roll 96 (e.g., approx. 1000 feet per minute) and directs the carton blanks 32 to the rotary accumulator 26. The rotary accumulator 26 changes the motion of the carton blanks from a substantially linear pathway to a substantially circular pathway. The in-feed assembly 142 provides control of the carton blanks 32 as they are directed into the rotary accumulator 26, which is particularly desirable in the handling of relatively short carton blanks (i.e., carton blanks having a length less than approximately one-half of the circumference of the rotary pathway). As described below in greater detail for FIG. 29, this feature provides for a “split-drum” or “two-around” mode of operating the accumulator section 24 in which separate batches of carton blanks 32 are formed on opposite sides of a drum 148 of the rotary accumulator 26.

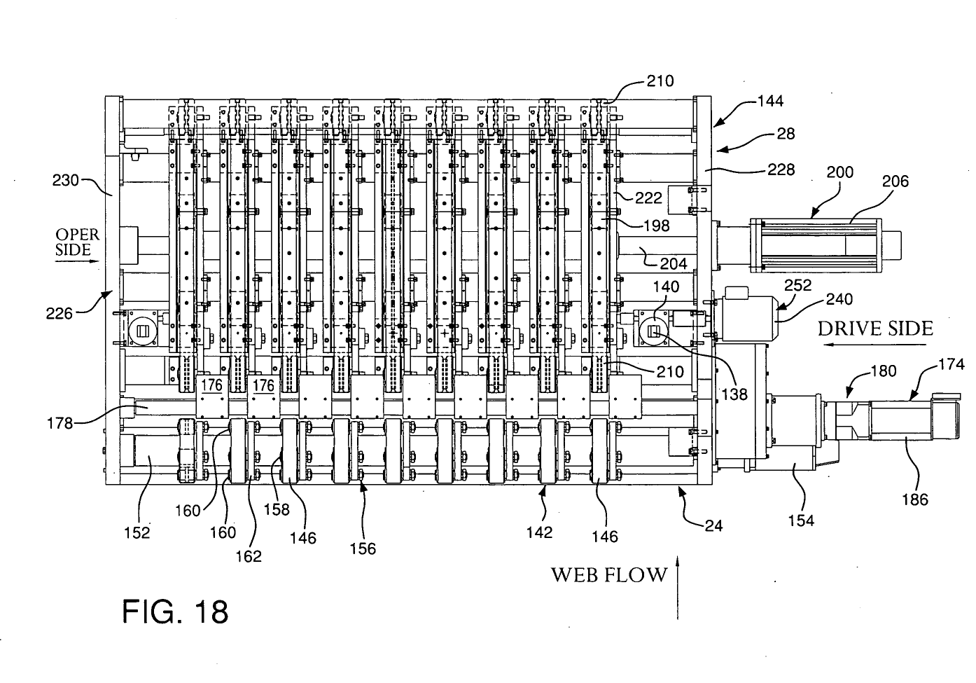

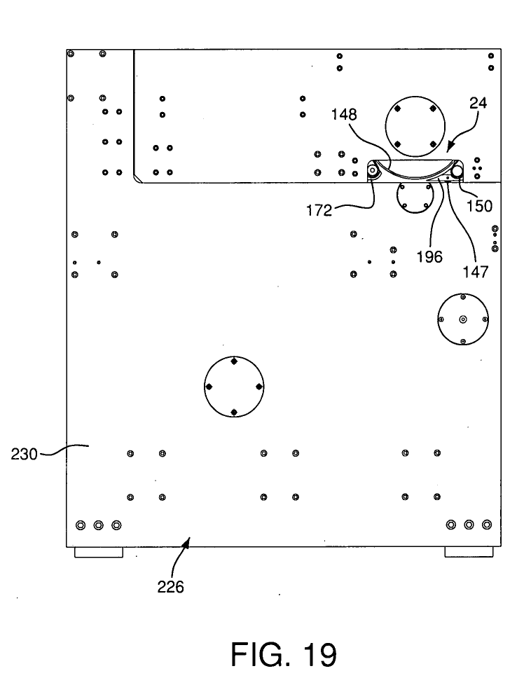

The in-feed assembly 142 of accumulator section 24 includes a plurality of in-feed belts 146 supported on a base assembly 144 and a cam assembly 147 located above the in-feed belts 146. The cam assembly 147 includes sloped cam surfaces defined by mount members of an in-feed bar assembly 150, described in greater detail below, and cam follower wheels rotatably supported by the in-feed bar assembly 150 adjacent to the cam surfaces. The sloped cam surfaces of cam assembly 147 direct the carton blanks 32 downwardly towards the associated belts 146 of the in-feed assembly 142. The cam follower wheels of cam assembly 147 contact the carton blanks 32 from above the carton blanks to define nip points with the associated belts 146 located beneath the carton blanks opposite the cam follower wheels. As shown in FIG. 18, the in-feed assembly 142 includes nine (9) in-feed belts 146. The in-feed assembly 142 includes an elongated belt drive roll 152 extending perpendicular to the in-feed belts 146 (i.e., extending in the cross-machine direction) and a servomotor 154 for rotatingly driving the belt drive roll 152. As shown in FIG. 16, the in-feed belts 146 are received about the belt drive roll 152 for rolling contact such that the in-feed belts 146 are driven by the belt drive roll 152. The in-feed assembly 142 also includes a plurality of belt idler assemblies 156, one for each of the in-feed belts 146. The belt idler assembly 156 includes a lower guide pulley 158 and a pair of upper crowned pulleys 160 rotatably mounted on a pulley mount 162. The controller of the carton handling system 10 preferably directs the servomotor 154 to drive the in-feed belts 146 such that the carton blanks 32 are moved at the same speed as set for the carton blanks 32 by the pull roll 96 of the accumulator section 22.

The drum 148 of the rotary accumulator 26 is rotatingly driven by a servomotor 164. In the view shown in FIG. 16, the drum 148 rotated by the servomotor 164 in a clockwise direction. The rotary accumulator 26 includes a plurality of drum belts 166 mounted on rollers 168 for rolling contact between the belts 166 and the drum 148. Arranged in this manner, the drum belts 166 are driven by the drum 148 as the drum 148 is driven by the drum servomotor 164. The rollers 168 for the drum belts 166 are supported by an upper bar assembly 170, the above-mentioned in-feed bar assembly 150, and an outgoing bar assembly 172. The rollers 168 maintain the drum belts 166 in the configuration shown in FIG. 16. As shown in FIG. 17, the rotary accumulator 26 includes seventeen (17) drum belts 166 mounted on the rollers 168 in spaced fashion along the length of the drum 148. As described below, the drum servomotor 164 is directed to move the carton blanks 32 about the rotary pathway defined by the accumulator 26 at a rate that provides for alignment between the carton blanks 32 on the drum 148 and succeeding carton blanks 32 directed to the rotary accumulator 26 from the in-feed assembly 142.

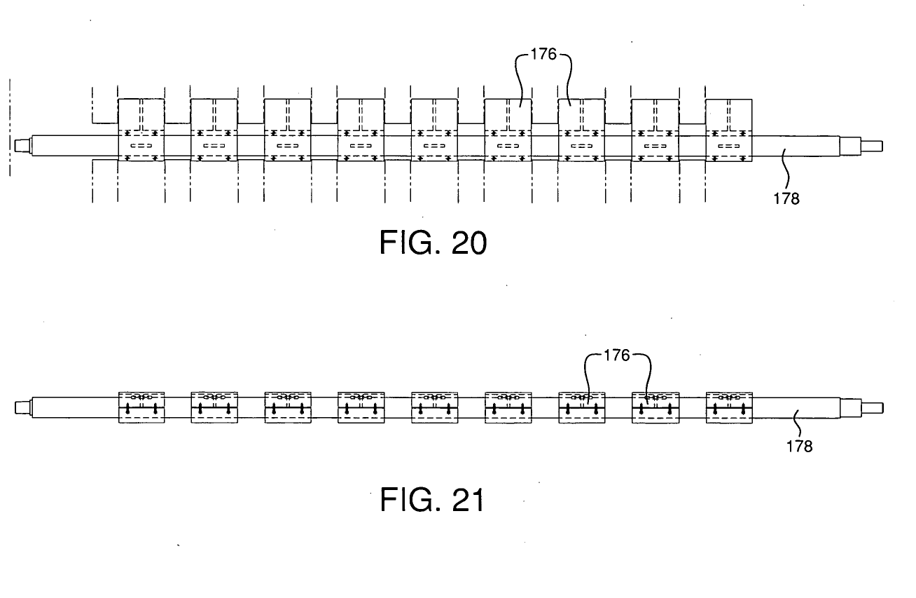

The rotary accumulator 26 includes a deflector assembly 174 for redirecting the carton blanks 32 from a substantially linear path towards the drum 148 for movement in a rotary (i.e., circular) path. Referring to FIGS. 20 and 21, the deflector assembly includes a plurality of deflector vanes 176 mounted on an elongated vane shaft 178. As described below, the deflector assembly 174 is movable between an up-vane position in which carton blanks 32 from the in-feed assembly 142 are upwardly redirected towards the rotary path defined around the drum 148 and a down-vane position in which the carton blanks 32 are permitted to continue along a substantially linear path beneath the drum 148. Both the up-vane and down-vane positions of the deflector assembly 174 are illustrated in FIG. 1 and in FIG. 16.

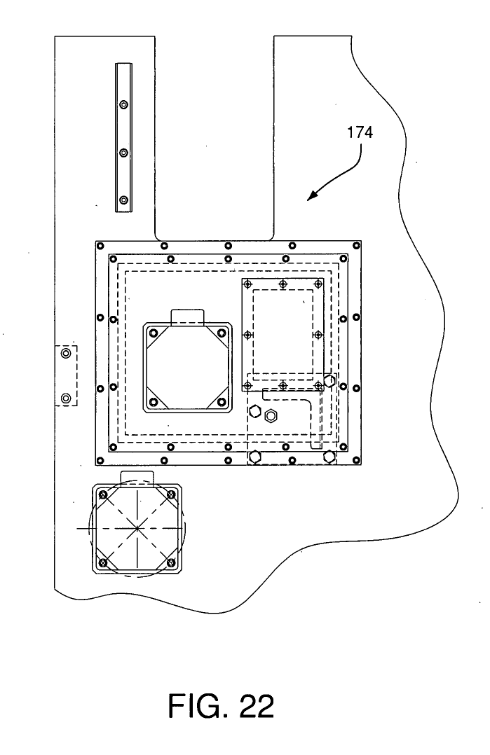

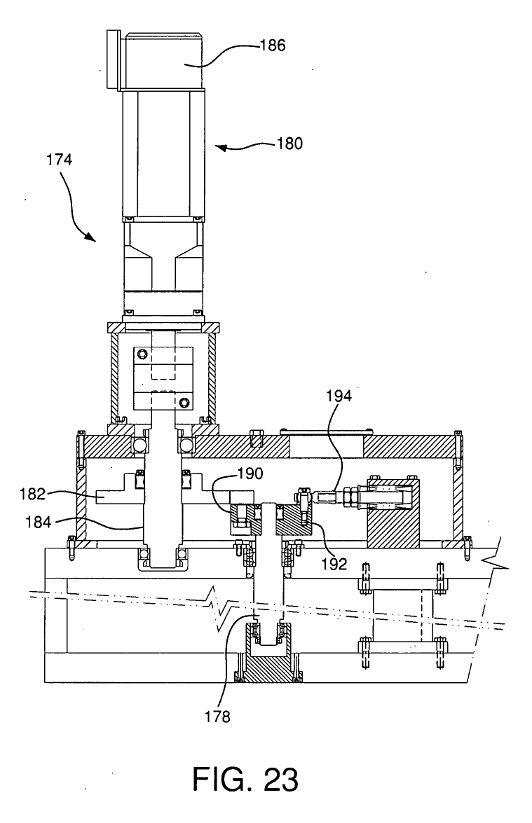

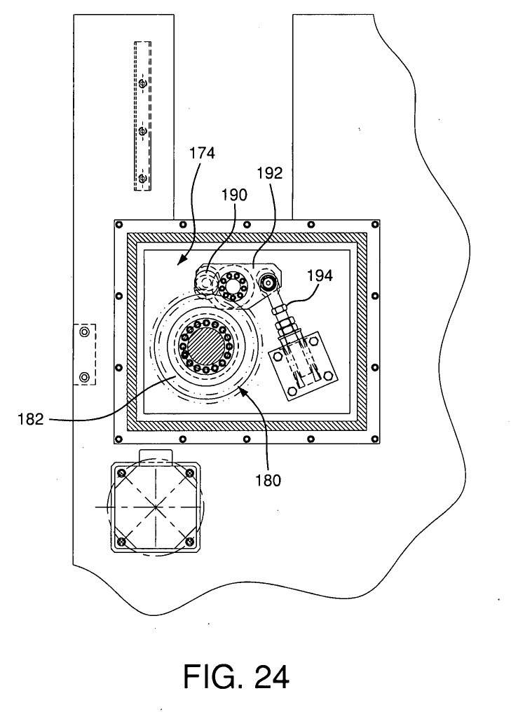

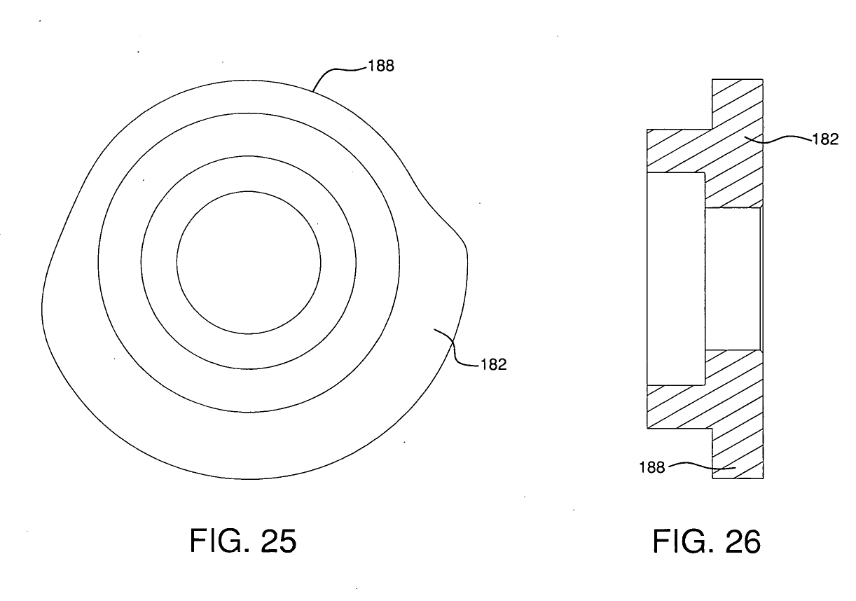

Referring to FIGS. 22 through 26, the deflector assembly 174 includes a vane drive assembly 180 adapted to move the deflector vanes 176 between the up-vane and down-vane positions illustrated in FIG. 16. The vane drive assembly 180 includes a vane cam 182 (FIGS. 25 and 26) mounted on a cam shaft 184. The cam shaft 184 is driven by a servomotor 186 to rotate the vane cam 182 between a lowered cam surface position (shown in FIG. 25) associated with the down-vane position and a raised cam surface position associated with the up-vane position. To move the deflector vanes 176 to the up-vane position, the vane cam 182 is rotated by the servomotor 186 to move an enlarged radius portion 188 of the vane cam 182 from the position shown in FIG. 25 to an upwardly located position.

The vane cam 182 is in rolling contact with a cam follower 190 rotatingly mounted on a rocker arm 192. The rocker arm 192 is coupled to the vane shaft 178 such that movement of the vane cam 182 between the lowered cam surface position of FIG. 25 to a raised cam surface position causes the rocker arm 192 to pivot, thereby shifting the attached deflector vanes 176 from the down-vane position to the up-vane position. A spring-loaded shaft 194 is coupled to the rocker arm 192 opposite the cam follower 190 to ensure that contact is maintained between the cam follower 190 and the vane cam 182.

When the deflector vanes 176 are moved to the up-vane position, the incoming lanes of carton blanks 32 are directed upwardly towards the drum 148. The carton blanks 32 are maintained in a rotary path about the drum 148 because of the location of the carton blanks 32 between the outer drum surface and the drum belts 166. The rotary accumulator 26 includes incoming guide surfaces 196 (FIG. 1) defined along an upper periphery of the mount members of the in-feed bar assembly 150. The incoming guide surfaces 196 are adapted to maintain the moving carton blanks 32 in the rotary path defined about the drum 148 as the carton blanks 32 come out of contact with the drum belts 166 adjacent the in-feed bar assembly 150.

It is preferably that a gap of approximately 2.5 inches or more be provided between the carton blanks 32 in each lane. Such a gap provided between the individual carton blanks 32 of a lane provides time for the movement of the deflector assembly 174, particularly for the movement of the deflector assembly 174 from the down-vane position to the up-vane position. For a drum 148 having a diameter of approximately 13 inches, the circumference of the drum is approximately 40.84 inches (i.e., π times diameter). A length of approximately 38 inches for the carton blank 32 is, therefore, considered a maximum practical length on a thirteen-inch diameter drum. As described below in greater detail, however, the drum 148 is preferably part of a removable module providing for ready replacement of modules having different drum, thereby facilitating efficient handling of variously sized carton blanks. For example, the above-discussed thirteen-inch diameter drum could readily be removed and replaced with a fifteen-inch diameter drum having a circumference of approximately 47.12 inches, thereby increasing the maximum practical carton blank length received onto the drum from approximately 38 inches to approximately 44.5 inches (i.e., 47 inches minus approximately 2.5 inches).

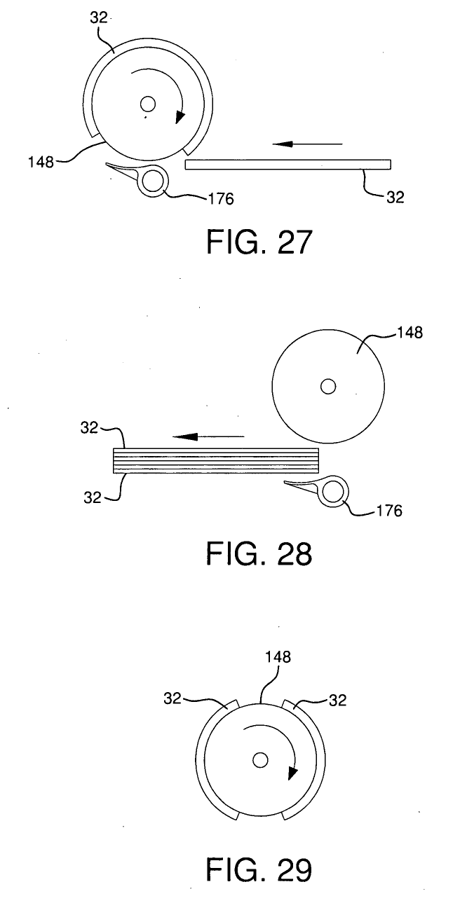

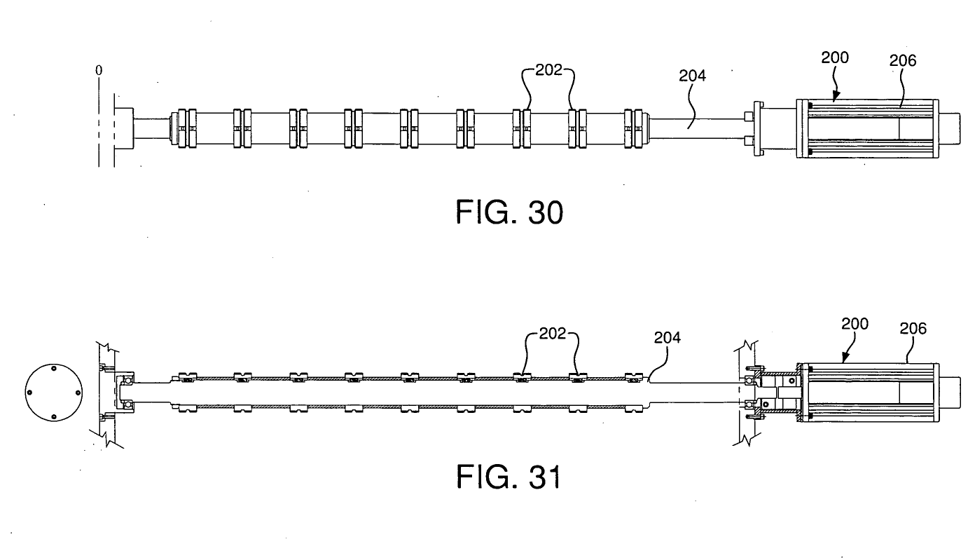

Referring now to FIGS. 27 through 29, two differing modes of operating the accumulator section 24 to form batches of stacked carton blanks 32 are illustrated schematically. In the first mode shown in FIGS. 27 and 28, the carton blanks 32 are received onto the drum 148 such that only one batch of carton blanks 32 is forming on the drum at any given time in each lane of carton blanks. This mode, therefore, may be hereinafter referred to as “single batching” mode or “one around” mode. As shown, the carton blanks 32 are directed about the rotary path defined by the accumulator 26 at a rate that provides for alignment between the leading end of the carton blank 32 and the next succeeding carton blank 32 of the lane. In order to provide for the desired alignment between a carton blank 32 rotating on the drum 148 and the next incoming carton blank 32, it should be understood that the controller for the carton handling system 10 will set the speed of the accumulator drum 148 so that it makes exactly one revolution for every carton entering the carton handling system 10. Since the speed of the pull roll 96, described above, and transfer belts 36, described above, follow and match the speed of the accumulator drum 148, this creates the fact that the linear speed of the carton blanks 32 along the rotary path of the accumulator 26 will need to be faster than the carton speed set by the rotary cutting device and skew unit. This increase in speed is necessary to close the above-described longitudinal gap provided between the individual carton blanks 32 and to account for differences between the drum circumference and the length of the carton blanks 32 since the circumference will likely be greater than the carton blank length. Considering again the above-mentioned 13 inch diameter drum 148 (i.e., 40.84 inch circumference), the practical range in length for the carton blank 32 being handled on the drum in a single batching mode is between approximately 19 inches as a minimum and the above-mentioned maximum length of 38 inches. The resulting surface speed needed for the carton blanks 32 along the rotary path defined by the accumulator 26 having the thirteen inch diameter drum 148 will range between about 107 percent of the carton speed set by the rotary cutting device (for handling carton blanks at the maximum practical length of 38 inches) and 214 percent (for handling carton blanks at the minimum practical length of approximately 19 inches).

As a result of the alignment provided between each carton blank 32 and the next succeeding carton blank in the lane, the carton blanks 32 will be placed atop each other to form a batch of stacked carton blanks 32. A carton blank 32 will be added to the batch moving about the rotary path of the accumulator 26 for each revolution of the drum 148 that the deflector assembly 174 remains in the up-vane position. When the deflector assembly 174 is moved to the down-vane position to discharge the batch from the accumulator 26, the existing batch moving about the rotary path will be directed downwardly from the drum 148 onto the next succeeding carton blank 32 directed from the in-feed assembly 142. The number of carton blanks 32 in the rotating stack of carton blanks 32 can be increased by maintaining the deflector vanes 176 in the up-vane position illustrated in FIG. 27. After a selected number of rotations of the drum 148 with the deflector vanes 176 in the up-vane position, the deflector vanes are lowered to the down-vane position shown in FIG. 28. As discussed above, the batch formed on the rotary path is directed downwardly onto the next incoming carton blank 32 from the in-feed assembly 142. As illustrated in FIG. 28, the completed batch of carton blanks 32 is then discharged beneath the drum 148 of the rotary accumulator 26 along a substantially linear path.

In FIG. 28, the thickness of the carton blanks 32 in the completed batch of carton blanks 32 is exaggerated to facilitate the illustration. The depicted batch of carton blanks 32 being discharged from the rotary accumulator 26 in the single batching mode includes five carton blanks 32. The invention, however, is not limited to any particular number of carton blanks 32 collected in the batches. It is believed, however, that limiting the number of carton blanks 32 to five or less in each batch would facilitate an optimum operation of the rotary accumulator 26.

In above-described single batching mode shown in FIGS. 27 and 28, each incoming carton blank 32 directed to the rotary path of the accumulator 26 from the in-feed assembly 142 is added to the single batch that is being formed about the rotary path of the accumulator 26. Therefore, the vanes 176 of the deflector assembly 174 will be maintained in the up-vane position in a single batching mode during a time period in which the drum 148 rotates a full number of revolutions ranging between 1 and 4 revolutions in order to form batches having between 2 and 5 carton blanks 32, respectively. This results because the stack of carton blanks 32 moving about the rotary path of the accumulator 26 is directed downwardly onto the next incoming carton blank 32 following the movement of the deflector assembly 174 to the down-vane position.

Referring to FIG. 29, an alternative second mode of operating the carton handling system 10 is illustrated. As shown, the length of the carton blanks 32 with respect to the circumference of the drum 148 is selected to provide for receipt of carton blanks 32 on each of opposite sides of the drum 148 at the same time. Again considering a 13-inch diameter drum (i.e., approx. 40.84 inch circumference), a practical range in the length of carton blanks 32 handled in a two-around mode is between approximately 14 inches and 19 inches. In the second mode separate batches can be formed about the rotary path of the accumulator 26 at the same time. This second mode, therefore, may be hereinafter referred to as the “double batching mode” or the “two-around mode”. As should be understood, the carton blanks 32 will not be aligned in successive manner like the single batching mode and, instead, will align in an alternating fashion (i.e., two batches respectively including carton blanks 1, 3, 5, etc. and 2, 4, 6, etc. formed from a series of incoming carton blanks 32).

The rotary speed of the drum 148 is selected to provide for the above-described alignment between alternating carton blanks 32 in each lane of carton blanks. As should be understood, the controller for the carton handling system 10 sets the speed of the accumulator drum 148 so that it makes exactly one revolution for every two cartons entering the carton handling system 10. Since the speed of the pull roll 96, described above, and transfer belts 36, described above, follow and match the speed of the accumulator drum 148, the required surface speed for the carton blanks 32 moving about the rotary path of the accumulator 26 in the double batching mode will need to be faster than the speed set by the rotary cutting device for similar reasons as those discussed above for the single batching mode. For a thirteen-inch diameter drum, the required surface speed for the carton blanks 32 moving about the rotary path of the accumulator would range between approximately 107 percent of the speed set by the pull roll 96 (for carton blanks 32 having 19 inch length) and approximately 146 percent (for carton blanks 32 having 14 inch length).

As shown in FIG. 29 and described above, the system 10 is adapted to form separate batches on opposite sides of the drum 148 in the two-around mode. As should be understood, therefore, the deflector assembly 174 will be controlled in the double batching mode in such a manner that the separate batches formed on the drum 148 can be discharged from the opposite sides of the drum (i.e., batch formation and discharge is tracked in terms of one-half (½) revolutions of the drum 148 instead of the entire revolutions associated with the single batching mode).

As discussed above, the formation of batches in the rotary accumulator 26 provides increased space between the batches discharged from the rotary accumulator 26 as compared to the spacing between the individual carton blanks 32 directed into the accumulator 26. This increased space provides for the desired slowing down of the carton blanks in the slow-down section 28. Therefore, it is desirable that the discharge of batches of carton blanks 32 from the opposite sides of the drum 148 in the double batching mode be staggered. As should be understood, it would not be desirable to discharge the batches from the opposite sides of the drum 148 in successive half-revolutions of the drum such that the batches are discharged adjacent each other.

The carton handling system 10 could be operated in double batching mode in the following manner to form batches containing three (3) carton blanks. As should be understood, each carton blank 32 that is brought into the rotary path of the accumulator 26 (i.e., deflector assembly 174 in the up-vane position) will first enter into the rotary path on a downstream side of the rotary accumulator 26 and will be then be directed along the rotary path to an upstream side of the accumulator. The carton blank 32 will then be either directed about the rotary path again, or will be discharged from the rotary accumulator, depending on the position of the deflector assembly 174. To facilitate the following description of the three batch method, the carton blanks 32 that are in the rotary path may be described as being located on either the upstream side or the downstream side of the rotary accumulator 26 during a given half-revolution of the drum 148.

The drum 148 should initially be rotated one full revolution with the deflector assembly 174 in the up-vane position such that a carton blank 32 is moving into the rotary path on both the upstream and downstream side of the rotary accumulator 26 in each lane. As discussed above, the formation and discharge of the batches is preferably staggered on the opposite sides of the drum 148 to create the desired space between discharged batches needed for the slow-down feature. To establish the desired stagger in the batch discharge, the deflector assembly should be lowered to the down-vane position during the next half-revolution following the initial one full revolution of the drum. As should be understood, this discharge will create a batch in each lane containing only two (2) carton blanks 32 (i.e., the carton blank 32 on the upstream side of the accumulator 26 after the first full revolution will be directed onto the next incoming carton blank 32 during this next discharging half-revolution). During the initial discharging cycle (i.e., half-revolution with the deflector assembly 174 in the down-vane position), the carton blank 32 from the downstream side will have moved about the rotary path to the upstream side of the accumulator 26 and the downstream side of the rotary path will be empty. As should be understood, the downstream side is empty because the carton blank 32 that would have been in this location was discharged as part of the initial batch containing only 2 cartons. In this manner, the desired stagger in the batch formation and discharge is established. Batches containing three (3) carton blanks can now be formed on, and discharged from, opposite sides of the drum 148 in a uniformly spaced-apart manner by repeating the pattern of rotating the drum 148 one full revolution with the deflector assembly 174 in the up-vane position and then discharging a batch during the next half-revolution. This forms batches of three because, as should be understood, the single carton blank 32 that was located on the upstream side of the accumulator 26 following a given discharge cycle will have a second carton blank added to it during the next revolution of the drum 148. This stack of two carton blanks 32 will then be directed out of the rotary path during the next discharging cycle onto an incoming carton blank 32 to form the desired batch having three carton blanks.

The number of carton blanks 32 in uniformly discharged batches can be increased from three by increasing the number of revolutions of the drum 148 between the discharging cycles. For example, batches having five (5) carton blanks can be formed by increasing the drum revolutions between discharging cycles to two full revolutions. In order to establish desired stagger in batch formation and discharging on the opposite sides of the drum 148, the drum should initially be rotated two full revolutions to build stacks of two carton blanks on each side of the drum 148. This should then be followed by an initial discharging cycle that creates a first batch having only three carton blanks 32. The desired stagger is now established because a stack of two carton blanks is located on drum 148 on the upstream side of the accumulator 26 while the opposite side of the drum 148 on the downstream side is empty. As should be understood, repetition from this point forward of two full revolutions of drum 148 in the up-vane position of deflector assembly 174 followed by a discharge cycle will result in uniformly spaced-apart batches in each lane containing five carton blanks 32. The invention is not limited to batches including five or fewer carton blanks 32. Limiting batches to five or fewer carton blanks 32 should provide for optimal operation of the carton handling system 32.

The Slow-Down Section

The slow-down section 28 of carton handling system 10 is adapted to reduce the speed of the batches of carton blanks 32 created by the accumulator section 24 from the speed at which the carton blanks are discharged from the accumulator section 24. As discussed above, this reduction in speed greatly reduces impact forces acting on the carton blanks 32 during subsequent transfer of the carton blanks 32 onto the relatively slowly moving collector conveyor 20, thereby facilitating an orderly and predictable transfer.

Referring to FIGS. 16-18, the slow-down section 28 includes a plurality of outgoing timing belts 198 adapted for contact with the batches of carton blanks 32 formed by the accumulator section 24 to move the batches along an upper deck surface of the slow-down section 28. As shown in FIGS. 17 and 18, the slow-down section 28 includes nine (9) outgoing timing belts 198. The slow-down section 28 has a timing belt drive assembly 200 including a drive shaft 204 driven by a servomotor 206. The timing belt drive assembly 200 also includes a plurality of drive pulleys 202, one for each of the outgoing timing belts 198, mounted on the drive shaft 204. The outgoing timing belts 198 are received by the drive pulleys 202 for rolling contact such that the outgoing timing belts 198 are driven by the drive pulleys 202.

The slow-down section 28 includes a plurality of idler pulley assemblies 208, one for each of the outgoing timing belts 198, for maintaining the outgoing timing belts 198 in the configuration shown in FIG. 16. The idler pulley assembly 208 includes a pair of upper idler pulleys 210 located adjacent the upper deck surface of the slow-down section 28 along which the batches of carton blanks 32 are directed. The idler pulley assembly 208 also includes a lower idler pulley 212 located below the upper idler pulleys 210. Each of the upper pulleys 210 and the lower pulley 212 is rotatably mounted on a pulley mounting bracket 214.

The slow-down section 28 also includes a plurality of belt tensioners 216, one for each of the outgoing timing belts 198. The belt tensioner 216 comprises a pulley 218 rotatably mounted on a bracket 220 for contact with the associated outgoing timing belt 198 to apply a desired tension to the outgoing timing belt 198. In a similar manner as the lane adjustment section 22, the slow-down section 28 includes a plurality of slide bed assemblies 222 defining track-like interiors for receiving the outgoing timing belts 198 and guiding them along the upper deck surface of the slow-down section 28

Similar to the lane adjustment section 22, a small gap is provided between the belt slide assembly 222 and the outgoing timing belts 198 to minimize potential friction caused by the belts contacting the slider base. The slider base 222, however, provides a means of controlling the vertical position of the belt path when the skate wheel assemblies 72, described below, exert their nip force on the folding cartons to assure that the speed of the folding carton matches that of the transfer belts 36.

Similar to the lane adjustment section 22, the slow-down section 28 includes sets of skate wheel assemblies 72, one set for each of the outgoing timing belts 198, for maintaining contact between the batches of carton blanks 32 and the outgoing timing belts 198. As shown in FIG. 1, each set of skate wheel assemblies 72 in the slow-down section 28 includes three skate wheel assemblies 72 spaced along the running length of the slow-down section 28 and supported by a beam 224.

As described above, the creation of the batches of stacked carton blanks 32 in the accumulator section 24 of the carton handling system 10 results in increased space between successive batches in a given lane compared to the space previously provided between the individual carton blanks upstream of the accumulator. As should be understood, this increased space between the batches results in a corresponding increase in time that it would take successive batches of carton blanks in a lane to pass a given point. The increased time between passage of successive batches of carton blanks 32 provides for the desired speed reduction in the slow-down section 28 through cyclic variation in the speed at which the slow-down belts 198 are driven by servomotor 206 as follows. When the batches of carton blanks 32 are being discharged to an inlet end of the slow-down section 28 from accumulator section 24, the servomotor 206 of the slow-down section 28 should drive the belts 198 at substantially the same speed as the carton blanks 32 were moved in the rotary path of the accumulator 26 (e.g., 107 percent to 146 percent of the pull roll speed in the above-described application). As should be understood, such substantial matching between the speed of belts 198 and the rotary path speed facilitates the transfer of the carton blanks 32 from the accumulator section 24 to the slow-down section 28. Before the next successive group of batches of carton blanks 32 are directed to the slow-down unit 28, the servomotor 206 is slowed by the controller such that the set of batches currently being driven by the belts 198 are discharged at an exit end of the slow-down unit 28 at a speed that is greatly reduced from the inlet speed of the batches. For example, it is contemplated that batch speed could be reduced from approximately 1200-1400 feet per minute at the inlet end to approximately 300 feet per minute or less at the exit end. As should be understood, the belt speed will be returned (i.e., increased) to the carton inlet speed following discharge of the current set of batches and before the next set of batches enters the inlet end. Known servomotors are capable of varying speed for the belts 198 between the above speeds within approximately 50 milliseconds or less. However, the particular acceleration and deceleration capability for servomotor 206 is not critical so long as belt speed can be reduced to the desired speed between the inlet and exit of the batches and returned to the inlet speed before the next incoming batches reach the inlet end. As should be understood, the length for the slow-down section 28 may vary depending on the deceleration rate for the belt speed. However, it is contemplated that the above speed reductions can be accomplished over relatively short distances such as less than approximately 10 feet and possibly even as short as approximately 3 feet.

The carton handling system 10 includes a frames and spreaders assembly 226 for supporting the above-described elements of the accumulator section 24 and slow-down section 28. The frames and spreader assembly 226 includes a drive side frame 228 and an operator side frame 230. The assembly 226 includes elongated spreaders extending between the frames 228, 230. The spreaders of the assembly 226 include three lower spreaders 232, an in-feed belt spreader 234, a timing belt incoming spreader 236, and a timing belt outgoing spreader 238.

The carton handling system 10 also includes a screw jack assembly 240 (FIG. 16) mounted to the frames 228, 230 of the frames and spreaders assembly 226. The screw jack assembly 240 is located beneath the upper deck surface of the slow-down section 28 to facilitate clearing of jam-ups occurring above the screw jack assembly 240 (i.e., in the accumulator section 24 and slow-down section 28). Similar to screw jack assembly 122, the screw jack assembly 240 includes a pair of screw boxes 242 each supported on supports 244 respectively mounted to one of the opposite frames 228, 230 of the frames and spreaders assembly 226 and a pair of elongated lift screws 246 each extending though one of the screw boxes 242. An elongated connecting shaft 248 interconnects lift drive members 250 housed within the screw boxes 242 for simultaneous rotation of the lift drive members 250 by a drive motor 252 to raise or lower the lift screws 246 with respect to the screw boxes 242. Also similar to screw jack assembly 122, the screw jack assembly 240 of the slow-down section 28 includes a plurality of limit switches 254 for limiting the range of movement of the lift screws 246.

The use of servomotors in carton handling system 10 provides the speed control for desired features such as the alignment of lanes in the lane adjustment section 22, the control of surface speed in the rotary path of accumulator 26 for batching, and the cyclic variation of belt speed in the slow-down section 28 for carton batch speed reduction. The depicted carton handling system 10 includes nine (9) servomotors. This includes the four servomotors 54 driving the belts 36 of the lane adjustment section 22, the servomotor 98 driving the pull roll 96 at the discharge end of the lane adjustment section 22, the servomotor 154 driving the belts 146 of the in-feed assembly 142, the servomotor 164 driving the drum 148, the servomotor 186 driving the deflector assembly 174, and the servomotor 206 driving the belts 198 of the slow-down section 28.

Modular Construction for Rotary Accumulator

The drum 148 of the rotary accumulator 26 is preferably part of a self-contained drum module assembly adapted to facilitate removal of the drum module from the system 10. Such ready removability of the drum module facilitates replacement of one module with another (e.g., modules having drums of different diameter). As described above, the diameter of the drum 148 defines the limits for the length of the carton blanks 32 that can be handled by the carton handling system 10. Increasing the drum diameter from 13 inches to 15 inches, as described above for example, increases the maximum practical length of carton blanks 32 that can be handled by system 10 in a single batching mode from 38 inches to 44.5 inches. Similarly, increasing the drum diameter from 13 inches to 15 inches, increases the maximum practical length of carton blanks 32 that can be handled by system 10 in a double batching mode from 19 inches to 22 inches. A modular construction that facilitates modification in the drum size, therefore, provides flexibility in the system 10 for handling a wide range of carton blanks 32. It is contemplated that the system 10 include a set of modules having drums ranging in diameter from 11 inches to 15 inches.

Preferably, the drum module includes the drum 148, the servomotor 164, the belts 166, the rollers 168, and the bar assemblies 150, 170, 172 supporting the rollers. Preferably, the drum module is removably supported between the frame members 228, 230 of the frames and spreader assembly 226 supporting the accumulator section 24 and slow-down section 28. In this manner, the drum module can be readied for removal from the system simply by disconnecting electrical connections associated with the servomotor 164.

To facilitate the removal of the drum module assembly from the carton handling system 10, the screw jack assemblies 122 and 240 could be used to support and lift the drum module with respect to the frames and spreader assemblies by using suitable lift structure received on the forked heads 138 of the lift screws 128.

The foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A system for handling carton blanks arranged in a plurality of spaced lanes of carton blanks moving in a running direction and for delivering the carton blanks to a collecting conveyor in a folding carton manufacturing process, the system comprising:
a lane adjustment section having an inlet end for receiving the lanes of carton blanks moving at a line operating speed and an opposite discharge end, the lane adjustment section including a plurality of transfer assemblies each adapted to move one of the lanes of carton blanks from the inlet end towards the discharge end, each of the transfer assemblies including a variable speed drive motor for individually adjusting the speed of the associated lane to align the lanes with each other in a cross-machine direction, the lane adjustment section further including a motor-driven pull roll extending in the cross-machine direction and located between the transfer assembles and the discharge end of the lane adjustment section for establishing a uniform speed for the lanes as they are discharged from the lane adjustment section;
an accumulator section receiving the lanes of carton blanks from the pull roll of the lane adjustment section, the accumulator section adapted to stack batches of carton blanks; and
a slow-down section receiving the batches of carton blanks from the accumulator section at an inlet end of the slow-down section at a first speed and discharging the batches from an opposite exit end to a collecting conveyor at a second speed reduced from the first speed, the slow-down section including a drive system having a variable speed motor for cyclically varying motor speed to adjust the speed of each batch of carton blanks from the first speed at the inlet end to the second speed at the exit end.

2. The handling and delivering system of claim 1, wherein the lane adjustment section includes a registration system adapted to monitor the lanes of carton blanks adjacent the inlet end of the lane adjustment section for misalignment between the lanes.

3. The handling and delivering system of claim 1, wherein each of the transfer assemblies includes a pair of transfer belts mounted on pulleys for movement of the belts about the pulleys and wherein the system further comprises a first set of skate wheel assemblies for maintaining contact between the carton blanks and the transfers belts, a second set of skate wheel assemblies for maintaining contact between the carton blanks and the pull roll and a third set of skate wheel assemblies for maintaining contact between the carton blanks and the belts of the slow-down section.

4. The handling and delivering system of claim 1, wherein the drive motor of each transfer assembly of the lane adjustment section is a servomotor and the drive motor of the slow-down section is a servomotor.

5. The handling and delivering system of claim 1, wherein the accumulator section includes a rotary accumulator, the rotary accumulator including:
a rotatably supported drum;
a drum motor rotatingly driving the drum;
at least one drum belt supported on rollers to contact an outer surface of the drum such that the drum belt is moved by the drum with respect to the rollers during rotation of the drum; and
a deflector assembly located beneath the drum, the deflector assembly movable between a raised position in which carton blanks moving in the running direction are directed upwardly towards the drum for movement about a rotary pathway between the drum and the drum belts and a lowered position in which the carton blanks pass beneath the drum in the running direction.

6. The handling and delivering system of claim 5, wherein the accumulator section includes an in-feed assembly located between the pull roll of the lane adjustment section and the deflector assembly of the rotary accumulator, the in-feed assembly including a plurality of belts each supported on pulleys and a drive roll, the in-feed assembly including a drive motor rotatingly driving the drive roll for movement of the in-feed belts about the pulleys and drive roll,
the in-feed assembly defining a nip point adjacent the deflector assembly to provide for both a single batching mode in which a single batch of stacked carton blanks are formed from the lane on the drum at any given time and an optional double batching mode in which relatively short carton blanks from the lane are received on each of opposite sides of the drum to form separate batches of stacked carton blanks from the lane at the same time.

7. The handling and delivering system of claim 6, wherein the in-feed assembly includes a plurality of cam assemblies located above the belts of the in-feed assembly, each cam assembly including a sloped cam surface for downwardly directing the carton blanks towards the belts of the in-feed assembly and a rotatably supported cam follower wheel located adjacent the cam surface, each of the cam follower wheels adapted to define a nip point with one of the belts of the in-feed assembly.

8. The handling and delivering system of claim 5, wherein the deflector assembly includes a plurality of vanes mounted on a vane shaft, a rotatably supported cam wheel and a servomotor drivingly rotating the cam wheel, and wherein the drum motor is a servomotor.

9. The handling and delivering system of claim 1 further comprising:
a frames and spreaders assembly supporting the lane adjustment section, the accumulator section and the slow-down section; and
at least one lift assembly secured to the frames and spreaders assembly and adapted to lift one or more components of the system with respect to the frames and spreaders assembly to facilitate maintenance or repair of the system.

10. A system for handling and delivering folding carton blanks arranged in a plurality of lanes of carton blanks moving in a running direction comprising:
an accumulator section for forming batches of stacked carton blanks in each lane, the accumulator section including a rotatably supported drum and a drum motor rotatingly driving the drum, the accumulator section including a deflector assembly located beneath the drum, the deflector assembly movable between a raised position in which carton blanks moving in the running direction are directed upwardly towards the drum for movement about a rotary pathway defined by the drum and a lowered position in which the carton blanks pass beneath the drum in the running direction; and
a lane adjustment section located upstream of the accumulator section for aligning the lanes of carton blanks with each other, the lane adjustment section including a registration system located adjacent an inlet end of the lane adjustment section to monitor the lanes of carton blanks for misalignment with each other in a cross machine direction, the lane adjustment section including a plurality of transfer assemblies each adapted to move one of the lanes in the running direction from the inlet end towards the discharge end, each of the transfer assemblies including at least one transfer belt mounted on pulleys and a drive motor for moving the transfer belt about the pulleys, the drive motor being a servomotor adapted to individually adjust the speed of the associated lane for aligning the carton blanks of the lanes in the cross-machine direction, the lane adjustment section including a motor-driven pull roll extending in the cross-machine direction adjacent a discharge end of the lane adjustment section for establishing a uniform accumulator speed for the carton blanks being discharged to the accumulator section.

11. The handling and delivering system of claim 10, wherein the accumulator system includes a plurality of drum belts supported on rollers and arranged such that the drum bolts are moved by the drum during rotation of the drum and wherein the drum motor is a servomotor.

12. The handling and delivering system of claim 10 further comprising:
a slow-down section located downstream of the accumulator section for slowing down the speed of the batches of stacked carton blanks formed by the accumulator section, the slow-down section including a plurality of belts mounted on pulleys and a drive system having a drive motor for moving the belts about the pulleys, and wherein the drive motor is a servomotor adapted to cyclically vary the speed of the motor to reduce the speed of each batch of carton blanks between an inlet end of the slow-down section and an exit end of the slow-down section.

13. A system for handling and delivering folding carton blanks arranged in a plurality of spaced lanes of carton blanks moving in a running direction, the system adapted to form batches of stacked carton blanks in each lane, the system comprising:
a rotatably supported drum;
a drive motor rotatingly driving the drum;
a plurality of drum belts;
a plurality of rollers on which the drum belts are mounted such that the drum belts are moved about the rollers by the drum during rotation of the drum; and
a deflector located beneath the drum, the deflector movable between a raised position in which carton blanks are directed upwardly towards the drum for movement about a rotary pathway between the drum and the drum belts and a lowered position in which the carton blanks pass beneath the drum in the running direction,
the drum, drive motor, drum belts and rollers included together as part of a drum module removably supported by a frame assembly to facilitate removal of the drum module from the frame assembly,
the system including a plurality of drum modules having drums of differing diameter.

14. The handling and delivery system of claim 13 further comprising at least one lift assembly secured to the frame assembly and adapted to lift the drum module with respect to the frame assembly to facilitate removal of the drum module from the frame assembly.

15. A method for handling folding carton blanks arranged in a plurality of spaced lanes moving in a running direction and delivering the folding carton blanks to a collecting conveyor comprising:
monitoring the lanes for misalignment between the lanes of carton blanks;
aligning the lanes by individually adjusting the speed of one or more of the lanes;
establishing a uniform speed for all of the lanes following the step of aligning the lanes;
forming batches of stacked carton blanks in each lane; and
slowing the speed at which each batch is moving in the running direction to limit impact forces acting on the batch during discharge of the batch to the collecting conveyor.

16. The method of claim 15, wherein the step of forming batches of stacked carton blanks includes the step of directing the carton blanks from the running direction into a rotary path defined by a rotating drum.

17. The method of claim 15, wherein the step of slowing the speed at which each batch is moving includes the step of cyclically varying the speed of a servomotor driving at least one belt of a slow-down section to reduce the speed of each batch of stacked carton blanks.

18. A method for handling folding carton blanks arranged in a plurality of spaced apart lanes moving in a running direction comprising:
providing a rotatably supported drum having a circumference sufficient to receive a carton blank on each of opposite first and second sides of the drum in each lane;
providing a drive motor rotatingly driving the drum;
providing a deflector located beneath the drum and movable between a raised position to upwardly direct the carton blanks towards the drum for movement about a rotary path defined by the drum and a lowered position in which the carton blanks pass beneath the drum in the running direction;
raising the deflector to the raised position;
maintaining the deflector in the raised position during at least one revolution of the drum such that at least one carton blank is directed into the rotary path onto each of the first and second sides of the drum in each lane;
lowering the deflector to the lowered position;
maintaining the deflector in the lowered position in a discharging cycle during a one-half revolution of the drum such that one or more stacked carton blanks from the first side of the drum in each lane are directed onto an incoming carton blank to form a batch of carton blanks moving in the running direction;
repeating the steps of raising, maintaining, lowering, and maintaining the deflector such that one or more stacked cartons are discharged from the second side of the drum in each lane onto an incoming carton blank to form a batch of carton blanks moving in the running direction; and
repeating the above steps of raising, maintaining, lowering, maintaining, and repeating such that carton blanks are discharged from the first and second sides of the drum in discharging cycles in alternating fashion to form batches of carton blanks.

19. The method of claim 18, wherein the deflector is maintained in the raised position for one full revolution of the drum between each discharging cycle.

20. The method of claim 18, wherein the deflector is maintained in the raised position for two full revolutions of the drum between each discharging cycle.
